(19) United States
(12) Patent Application Publication
(10) Pub. No.: US 2003/0204567 A1
(43) Pub. Date: Oct. 30, 2003

(54) System and method for creating e-mail object attributes

(75) Inventors: Gilford F. Martino, Endwell, NY (US); Frank J. Robyck, Endwell, NY (US); John F. McGraw JR., Endicott, NY (US)

Correspondence Address: IBM Corporation, Intellectual Property Law (Dept. 917, Bldg. 006-1), 3605 Highway 52 North, Rochester, MN, 55901-7829, US

(73) Assignee: International Business Machines Corporation, Armonk, NY

(21) Appl. No.: 10/133,179

(22) Filed: Apr. 26, 2002

(51) Int. Cl. G06F 15/16

(52) U.S. Cl. 709/206; 345/771

(57) ABSTRACT

Attributes are associated with E-mail objects by initializing a context window to include one or more action items for associating attributes with objects in a note; a display is responsive to user selection of an object for displaying the context window; responsive to user selection of an action item, selectable attributes are displayed in an object attributes window; and responsive to user selection of one or more attributes from the object attributes window, selected attributes are associate in the note with the object.

### BACKGROUND OF THE INVENTION

1. Technical Field of the Invention This invention relates to electronic mail notes. More particularly, it relates to associating attributes with note components for communicating information among the originator and receivers of the note without requiring appended notes.

2. Background Art

There are millions of e-mail users. Many of these users require the use of e-mail for their jobs. Typically these users rely, at least in part, on e-mail communications to share information regarding their respective projects or tasks. Users typically request in such e-mail notes information regarding a project or receive requests for actions to be completed.

Typically, a user owning a project receives several e-mail messages from several different people about changes to or problems with respect to the project. In response, the user typically must compose a message regarding each of the problems, who owns it and what is its status, such as a target date for resolution. This message is then returned to all of the people who need to know. Often times this is a greater group of people, who in turn respond with their concerns and this continues, with more and more appending of notes. This typically results in long notes including an original and many appended messages that are difficult to follow, or requires that a new note be composed with all of the important information re-entered or blocked and copied. Invariably problems are missed when people do not respond to these notes.

It is, therefore, an object of the invention to provide a system and method for sharing task progress within a single note, thus avoiding the requirement for a series of appended notes.

It is a further object of the invention to provide a system and method for maintaining in a note current status of projects without appending additional notes.

It is an object of the invention to provide a system and method for defining an object with an E-mail note that can be sent to a user, selectively updated, and returned to the originator.

It is a further object of the invention to provide a system and method for tailoring an object within an E-mail note to a specific task, thus providing for effective and concise communication relative to that task.

It is an object of the invention to provide a system and method for communicating work status via an E-mail note without requiring the use of a plurality of appended notes.

It is an object of the invention to provide a system and method for providing within an E-mail note an object for carrying changes to object attributes.

It is an object of the invention to provide a system and method within a single E-mail note for maintaining task attributes, such as status, which changes through time.

It is an object of the invention to provide a system and method for specifying object attributes from within an E-mail note during note creation and updating without requiring imbedding of tables, bitmap images, or freelance projects.

It is an object of the invention to provide a system and method for creating a distribution list in part from owners assigned to E-mail objects.

### SUMMARY OF THE INVENTION

A system and method for creating E-mail objects. A context window is initialized to include one or more action items for associating attributes with objects in a note; a display is responsive to user selection of an object, for displaying said context window; responsive to user selection of an action item, selectable attributes are displayed in an object attributes window; and responsive to user selection of one or more attributes from the object attributes window, selected attributes are associated in the note with the object.

In accordance with an aspect of the invention, there is provided a computer program product configured to be operable to create E-mail objects associated with user selected attributes.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a high level system diagram illustrating key components or objects of the preferred embodiment of the invention.

FIGS. 2A and 2B are a flow diagram of an illustrative embodiment of the method of the invention.

### BEST MODE FOR CARRYING OUT THE INVENTION

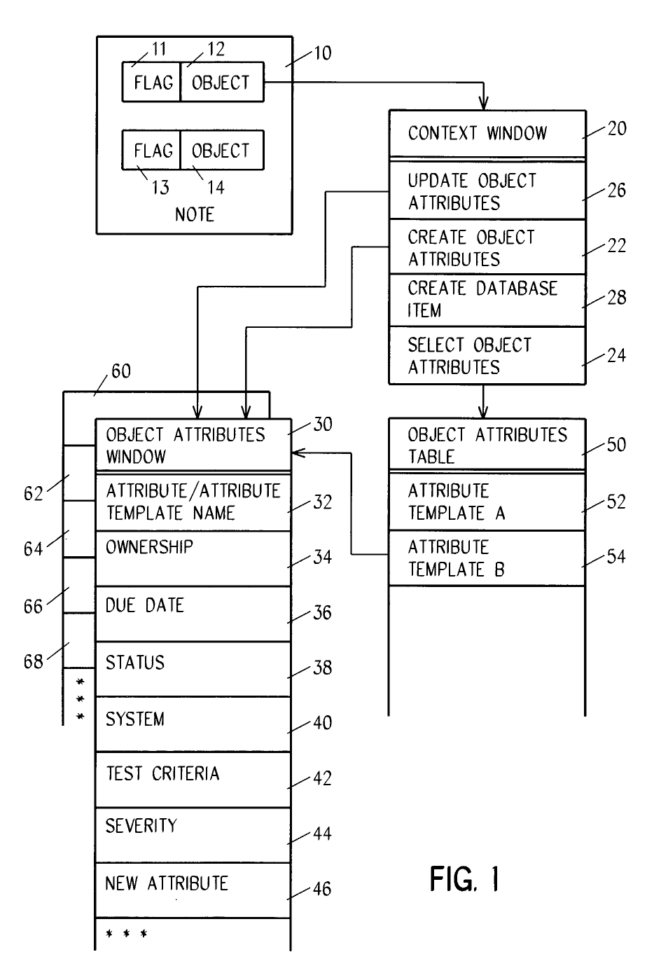

Referring to FIG. 1, in accordance with a preferred embodiment of the invention, a system and method is provided for creating one or more objects 12, 14 within an E-mail note 10 for which attributes 32-46 can be defined and values assigned to the attributes. Herein, an object 12, 14 is a data structure that is defined within an E-mail note 10. Such a data structure is defined in a manner that it has at least one attribute which is a variable field, which attribute may then be assigned a value.

The system of the preferred embodiment of the invention includes note 10 including one or more objects 12, 14 which may have associated flags 11, 13; a drop-down context window 20 including a plurality 22-28 of user selectable options, object attributes windows 30, an object attributes table 50, and an object attributes specification window 60. Context window 20 is displayed, typically, by right mouse click. In accordance with an exemplary embodiments of the invention, context window 20 is initialized to include an array of action items 24-26 by writing, for example, Java classes implementing for each action item an Action Manager which is executed in response to selection of the associated action item to perform the functions described hereafter. To write these Java Classes, a graphical user interface, such as the iSeries Navigator, may be used.

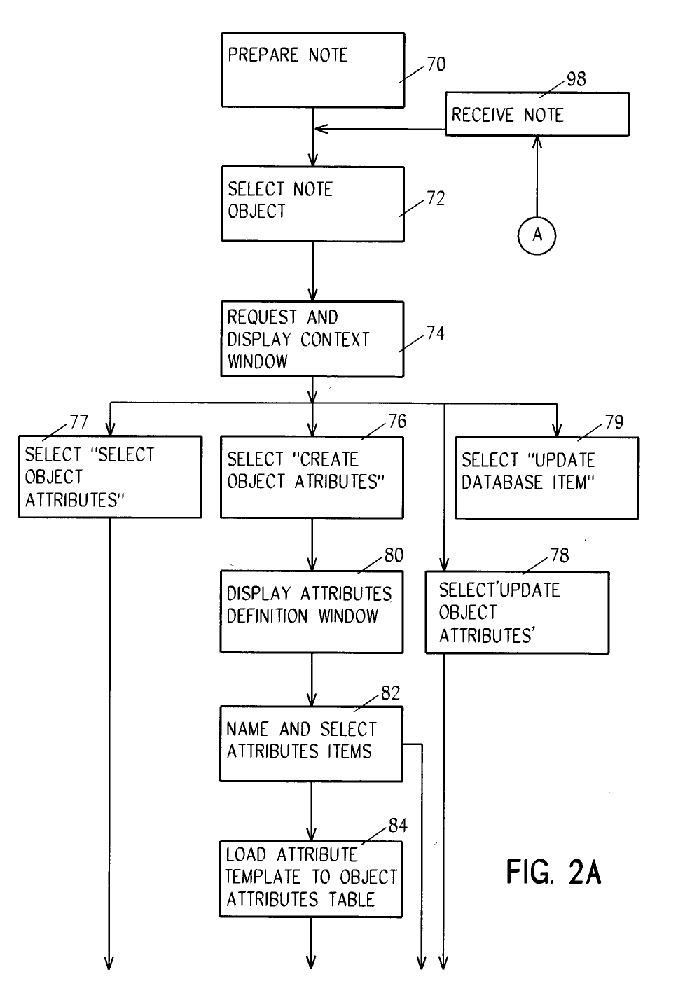

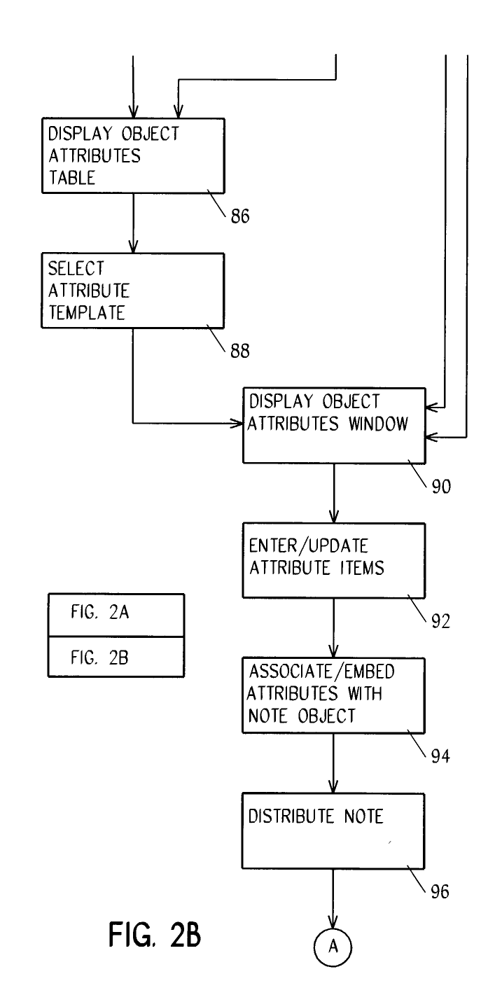

As will be more fully explained hereafter in connection with FIGS. 2A and 2B, an object 12, 14 defined within an E-mail note is sent to one or more E-mail users, selectively updated and returned by one or more of them to the originator of the note. By tailoring one or more objects 12, 14 within the note 10 to a specific task, effective communication may be realized between originator and receiver of the note with respect to that task.

In accordance with an exemplary embodiment of the invention, in order for the originator of an E-mail note to define an element of that note as an object to which the originator or subsequent users of the note can assign attributes, the originating user selects some portion of the note by highlighting or, if the ability is available, by drawing a line around the portion, which may be text, graphics, or some other section of the note. Then, using the toolbar, a drop down menu or context window 20, the user creates or initializes the selected area as an object 12 by causing the running program (such as, Lotus Notes) to associate a keyword (for example, ‘OBJECT_NEW_ATTRIBUTES_{—}1’) with the selected text or section of note 10.

After the note object 12 has been initialized as ‘OBJECT_NEW_ATTRIBUTES_{—}1’, the user selects that object 12 and using a toolbar or context window 20, selects ‘create attributes’ 22. This assigns a specific type to the object 12, and the running program responds by displaying a template in object attributes window 30 with the correct, available functions or attributes 32-46 for this object type. The user selects from the available functions or attributes those he desires for this specific object 12, specifies ranges or specific values for each selected function or object, and may save the resulting template in object attributes table 50.

Thus, a first E-mail user creates an object 12 within an E-mail note by selecting text and/or other data within the note and defining it as an object. With the object selected, a number of attributes 32-46 may be defined, including attribute type, name, permissions, and other meta-data.

By way of example, an object 12 named “problem” may have a first attribute with a type of “text” and a name of “owner” 34, a second attribute with a type of “date” and a name of “due date” 36, and a third attribute with a type of “text” and a name of “status” 38. The originator, or first E-mail user, assigns values to the attributes 34, 36, and 38 (in this example), such as a person's name and/or E-mail address in the “owner” attribute 34 and a date in the “due date” attribute 36. The originator of the E-mail note containing the “problem” object 12 then sends it to other e-mail users and requests that they fill in the “status” attribute 38 of the “problem” object 12 and return the note 10 to the originator.

In accordance with a further exemplary embodiment of the invention, the sender of an E-mail message selectively mark parts of a note 10 as particular objects 12, 14 and then assign those objects some attributes that are appropriate to the note in question. This is done by the user selecting with a mouse the object or bullet 12, 14, then using a key sequence like Ctrl-Z, or right click of the mouse, pops up (or down) a context window 20 which presents the user the menu including create object attributes 22. The running program displays context menu 20 when the mouse is right clicked in a frame, over a toolbar button, or a context menu that has an associated object name, and stores the contents of its working queue identified by that object name into the program's local storage area. This menu 20 is used to assign columns of attributes table 50. These columns may have had attributes previously defined by the user, and are accessed by select object attributes 24 to open a template from table 50, or may be for an attributes table 50 which the user desires to create by selecting create object attributes 22 and new attribute 46. Any number of attributes can be assigned, and each attribute is displayed in either a table format (this is optional) or as flyover text for the object. This will give the receiver of the note the power to respond to the sender and not have to re-type the information that was received, only to add attributes or change attributes of the current object.

By way of example, referring to FIG. 1, in accordance with an exemplary embodiment of the invention, a software tester is the originator of a note 10 which he sends to a software development team leader with a list of problems 12, 14 that have been encountered. The originator uses the mouse to select text 12 and then right clicks within the selected text to open a context window 20, which includes create object attributes item 22 and select object attributes item 24. Upon selecting create object attributes item 22, the originator is presented an object attributes window 30 containing a menu of object attributes 32-44. Using this menu, the problems in the list in note 10 are defined as objects 12, 14 to which the tester assigns attributes such as attribute name 32, owner 34, defines a current status 38, describes the system tested 40 and test criteria 42, sets a date due 36 and defines severity 44.

In accordance with another exemplary embodiment, upon the originator of note 10 selecting item create object attributes 22, object attributes specification window 60 first presents to the originator preliminary questions 62-68 for defining a set of attributes. This may be done in the following manner, with the question presented in object attributes specification window 60 followed by a typical response:

Question 62: What is the name of this object? Answer: Test problem.

Question 64: How many attributes are to be attached to this object? Answer: 4.

Question 66: What are the attributes? Answer: owner, status, due date, severity.

This response via object attributes specification window 60 presents in object attributes window 30 a context menu enabling the originator to enter data into ownership 34, status 38, due date 36 and severity 44 attribute fields. The other fields 32, 40, 42, 46 are greyed out or removed from object attributes window 30. The originator may also be given the option to,identify each attribute field as read only or as read/write to enable others to modify the attribute value. The object ‘Test problem’ is then embedded in note 10, optionally highlighted or associated with a flag 11, which note is then sent automatically to everyone identified as an owner 34 of objects 12, 14, and anyone else that is selected by the originator as recipients of note 10.

This newly created object called ‘Test problem’ may also be saved as one of attribute templates 52, 54 in object attributes table 50,,and used again by originators of notes who choose menu item select object attributes 24 when presented context window 20. The originator of a template 52, 54, and others granted authority, may also change a template 52, 54 by adding or deleting fields 32-44.

When note 10 is received by an individual, problem objects 12, 14 that are assigned to that individual may be highlighted, such as in a different color text. The receiving individual may then edit the modifiable object attributes 32-44 of, for example, object 12. This may be done by clicking on flag 11 or right clicking in object 12 to open context window 20, then select update object attributes 26. This opens object attributes window 30 with those attributes 32-44 assigned to object 12 by the originator displayed for viewing and/or updating. Changes made by the individual to attributes 32-46 may be displayed in a different color. The individual may then be provided the option of adding additional attributes to the original object 12, substantially as done by the originator.

In accordance with further exemplary embodiments of the invention, the originator (or subsequent users) of note 10 may create or associate with bullets, text, pictures, any note component, and/or the note itself, one or more attributes—either by creating a set of attributes as described above using object attributes window 30 or by selecting a previously created set of attributes from object attributes table 50 and associating flags 11, 13 with or highlighting those note components 12, 14 with which an attribute has been associated.

Flags 11, 13 in note 10 may be used to indicate to a user those note components 12, 14 that have associated attributes 32-44. By selecting a flagged component, the user is presented in a window 30 the associated component attributes. Some fields in that window may be read only, and others may be designated by the creator for input. After updating the attributes window, the user may indicate by flagging or otherwise highlighting a note component 12, 14 that work has been done in the attributes window 30, such as, for example, accepting ownership or entering requested data, and returned to the originator and others.

Continuing the example, suppose a note is sent to a number of people, one of whom, for example, accepts and edits the attributes window 30, and then sends out the edited note in response to everybody to which the original note was directed. Those receiving the response would see the original note, with edited components 12, 14 flagged to indicating the component has been accepted and perhaps updated. Receivers could, at their option, select whether to view the changes made. In this manner, receivers of note 10 may quickly identify the status of flagged components without having to search many appended notes.

In accordance with a further embodiment of the invention, menu item create database item 28 in context window 30 may be selected to create a database item, such as a Lotus Notes database item, to be associated with an object 12, 14 in note 10.

Referring now to FIGS. 2A and 2B, an exemplary embodiment of the method of the invention will be described. In step 70, a user prepares note 10. In step 72, the user uses a curser, for example, to select a note object 12 and then in step 74 right clicks (or uses a key combination such as CTL-ESC) to request display of context window 20. In this example, context window 20 has been initialized as previously described to present several options to the user, including create object attributes 76, select object attributes 77, update object attributes 78, and create database item 79. If the user selects create object attributes 76, then in step 80 an optional attributes definition window 60 is displayed, in step 82 to user names and selects attribute items as previously described, in step 84 an optional attribute template is loaded to attributes table 84, and in step 90 object attributes window 30 is displayed listing those attribute items 32-46 selected by the user by way of attributes definition window 60. If the user selects step 77, then object attributes table 50 is displayed in step 86, and in step 88 the user selects the desired attribute template which will then populate object attributes window 30 in step 90 with the attribute items 3244 specified by the selected attribute template 52, 54. In step 92, the user enters or updates attribute items 32-44. In step 94, the attributes pertinent to object 12 are embedded in note 10. In step 96 the user distributes note 10 to recipients who, in step 98, receive the note and process it. The list of addressees may be initialized to include all of those individuals named as having ownership 34, and the sender may add to that others who should receive the note. Typically, in step 72, recipients of the note will select a tagged or highlighted object 12, in step 74 request display of context window 20, and in step 78 select update object attributes 26—and then processing continues to steps 90-96 as previously described.

Advantages over the Prior Art

It is an advantage of the invention that there is provided a system and method for sharing task progress within a single note, thus avoiding the requirement for a series of appended notes.

It is a further advantage of the invention that there is provided a system and method for maintaining in a note current status of projects without appending additional notes.

It is a further advantage of the invention that there is provided a system and method for defining an object with an E-mail note that can be sent to a user, selectively updated, and returned to the originator.

It is a further advantage of the invention that there is provided a system and method for tailoring an object within an E-mail note to a specific task, thus providing for effective and concise communication relative to that task.

It is a further advantage of the invention that there is provided a system and method for communicating work status via an E-mail note without requiring the use of a plurality of appended notes.

It is a further advantage of the invention that there is provided a system and method for providing within an Email note an object for carrying changes to object attributes.

It is a further advantage of the invention that there is provided a system and method within a single E-mail note for maintaining task attributes, such as status, which changes through time.

It is a further advantage of the invention that there is provided a system and method for specifying object attributes from within an E-mail note during note creation and updating without requiring imbedding of tables, bitmap images, or freelance projects.

It is a further advantage of the invention that there is provided a system and method for creating a distribution list in part from owners assigned to E-mail objects.

Alternative Embodiments

It will be appreciated that, although specific embodiments of the invention have been described herein for purposes of illustration, various modifications may be made without departing from the spirit and scope of the invention. In particular, it is within the scope of the invention to provide a computer program product or program element, or a program storage or memory device such as a solid or fluid transmission medium, magnetic or optical wire, tape or disc, or the like, for storing signals readable by a machine, for controlling the operation of a computer according to the method of the invention and/or to structure its components in accordance with the system of the invention.

Further, each step of the method may be executed on any general computer, such as IBM Systems designated as zSeries, iSeries, xSeries, and pSeries, or the like and pursuant to one or more, or a part of one or more, program elements, modules or objects generated from any programming language, such as C++, Java, Pl/1, Fortran or the like. And still further, each-said step, or a file or object or the like implementing each said step, may be executed by special purpose hardware or a circuit module designed for that purpose.

Accordingly, the scope of protection of this invention is limited only by the following claims and their equivalents.

We claim:

1. A method for creating E-mail objects, comprising the steps of:
initializing a context window to include one or more action items for associating attributes with objects in a note;
responsive to user selection of an object, displaying said context window;
responsive to user selection of said action item, displaying an object attributes window including a plurality of selectable attributes; and
responsive to user selection of one or more attributes from said object attributes window, associating selected attributes with said object.

2. The method of claim 1, further comprising the step of:
initializing said context window to include action items for updating object attributes, creating object attributes, and selecting object attributes.

3. The method of claim 2, further comprising the steps of:
storing an attribute template in an object attributes table; and
responsive to said user selecting said action item for selecting object attributes, displaying in said object attributes window an attribute template selected from said object attributes table.

4. The method of claim 2, further comprising the steps of:
responsive to said user selecting said action item for updating object attributes, displaying in said object attributes window attributes associated in said note with said object.

5. The method of claim 3, further comprising the step of:
displaying to said user an object attributes specification window for defining a set of attributes.

6. The method of claim 5, further comprising the step of storing said set of attributes to said object attributes table.

7. The method of claim 1, further comprising the step of highlighting objects in said note to which attributes have been assigned.

8. The method of claim 7, further comprising the step of highlighting by flagging said objects to which attributes have been assigned.

9. The method of claim 1, said attributes including a plurality of attributes selected from the set including attribute name, ownership, due date, status, system, test criteria, severity, and new attribute.

10. System for creating E-mail objects, comprising:
a context window initialized to include one or more action items for associating attributes with objects in a note;
a display responsive to user selection of an object, for displaying said context window;
first code responsive to user selection of said action item for displaying an object attributes window including a plurality of selectable attributes; and
second code responsive to user selection of one or more attributes from said object attributes window for associating in said note selected attributes with said object.

11. The system of claim 10, said context window further comprising action items for updating object attributes, creating object attributes, and selecting object attributes.

12. The system of claim 11, further comprising:
an object attributes table for storing attribute templates; and
third code responsive to said user selecting said action item for selecting object attributes, for displaying in said object attributes window an attribute template selected from said object attributes table.

13. A program storage device readable by a machine, tangibly embodying a program of instructions executable by a machine to perform method steps for creating E-mail objects, said method steps comprising:
initializing a context window to include one or more action items for associating attributes with objects in a note;
responsive to user selection of an object, displaying said context window;
responsive to user selection of said action item, displaying an object attributes window including a plurality of selectable attributes; and
responsive to user selection of one or more attributes from said object attributes window, associating selected attributes with said object.

14. The program storage device of claim 13, said method steps further comprising:
initializing said context window to include action items for updating object attributes, creating object attributes, and selecting object attributes.

15. The program storage device of claim 14, said method steps further comprising:
storing an attribute template in an object attributes table; and
responsive to said user selecting said action item for selecting object attributes, displaying in said object attributes window an attribute template selected from said object attributes table.

16. The program storage device of claim 14, said method steps further comprising:
responsive to said user selecting said action item for updating object attributes, displaying in said object attributes window attributes associated in said note with said object.

17. The program storage device of claim 15, said method steps further comprising:
displaying to said user an object attributes specification window for defining a set of attributes.

18. The program storage device of claim 17, said method steps further comprising storing said set of attributes to said object attributes table.

19. The program storage device of claim 13, said method steps further comprising highlighting objects in said note to which attributes have been assigned.

20. The program storage device of claim 19, said method steps further comprising highlighting by flagging said objects to which attributes have been assigned.

21. The program storage device of claim 13, said attributes including a plurality of attributes selected from the set including attribute name, ownership, due date, status, system, test criteria, severity, and new attribute.

22. A computer program product or computer program element for creating E-mail objects according to method steps comprising:
initializing a context window to include one or more action items for associating attributes with objects in a note;
responsive to user selection of an object, displaying said context window;
responsive to user selection of said action item, displaying an object attributes window including a plurality of selectable attributes; and
responsive to user selection of one or more attributes from said object attributes window, associating selected attributes with said object.
